(19) United States
(12) Patent Application Publication
(10) Pub. No.: US 2019/0180189 A1
(43) Pub. Date: Jun. 13, 2019

(54) CLIENT SYNCHRONIZATION FOR OFFLINE EXECUTION OF NEURAL NETWORKS

(71) Applicant: SAP SE, Walldorf (DE)

(72) Inventors: Thomas Biesemann, Bruchsal (DE); Tim Kornmann, Reilingen (DE)

(21) Appl. No.: 15/837,161

(22) Filed: Dec. 11, 2017

(51) Int. Cl. G06N 3/10; G06N 3/04; G06N 3/08; H04L 29/08

(52) U.S. Cl. CPC G06N 3/10; H04L 67/1095; G06N 3/08; G06N 3/04

(57) ABSTRACT

Techniques are described for synchronizing existing neural networks to client devices for execution of the neural network in an offline mode. In one example method, a request to synchronize a trained neural network from a backend system to a client device is identified to enable offline neural network execution. In response, a neural network model defining the neural network is identified, wherein the model is associated with a current configuration. An input definition associated with the trained neural network is identified, wherein the input definition defines a set of data required as input for the trained neural network to execute. The set of data defined by the identified input definition is obtained, and a representation of the trained neural network is transmitted to the client device including an offline version of the neural network model, the current configuration of the trained neural network, and the obtained set of data.

### BACKGROUND

The present disclosure relates to a system and computerized method for providing capabilities for synchronizing existing neural networks to client devices for execution of the neural network in an offline mode.

Machine learning and artificial intelligence (AI) systems are an important innovation in software. Numerous companies and organizations have incorporated machine learning into their products and solutions to allow users to enhance existing business processes, decision-making, and predictive analytics based on historical information and experience. Machine learning can be based on neural networks, a particular machine learning discipline in computer science. Neural networks are computational models inspired by the way biological neural networks in the human brain process information, and are used in various machine learning-related operations. Example industries and activities where neural networks have found significant support and benefits include speech recognition, computer vision, and text processing. One example use case for understanding neural networks is in the detection and identification of handwritten numbers via a computer vision application. Numerous industries, including marketing, healthcare, fraud detection, portfolio management, and insurance underwriting, among others, employ and apply neural networks to increase productivity and functionality of their systems.

Modern cloud-based business software executes, at least partially, portions of the business application on client devices (e.g., mobile devices). In some cases, such applications support an offline mode where users can work on a mobile device to perform some operations even without network connectivity.

### SUMMARY

Implementations of the present disclosure are generally directed to providing extensibility tools to customers for defining custom restriction rules enabling enhanced and customizable access controls. In one example implementation, a computerized method executed by hardware processors can be performed. The example method can comprise identifying a request to synchronize a trained neural network from a backend system to a client device, wherein synchronizing the trained neural network to the client device enables offline execution of the trained neural network. In response to identifying the request, a neural network model defining the trained neural network is identified, the neural network model associated with a current configuration. An input definition associated with the trained neural network is identified, wherein the input definition defines a set of data required as input for the trained neural network to execute. The set of data defined by the identified input definition is obtained. Then, a representation of the trained neural network is transmitted to the client device, wherein the transmitted representation includes an offline version of the neural network model and the current configuration of the trained neural network and the obtained set of data.

Implementations can optionally include one or more of the following features. In some instances, the operations may include storing the representation of the trained neural network at the client device in response to the transmission. In some of those instances, in response to a request to execute the trained neural network at the client device, the client device executes the trained neural network using the offline version of the neural network model, the current configuration of the trained neural network, and the obtained set of data as previously provided to the client.

In some instances, the client device is a mobile device.

In some instances, the input definition defines at least one predefined query associated with the set of data required as input for the trained neural network to execute. In those instances, obtaining the set of data defined by the identified input definition can include executing the at least one predefined query on a set of backend data to obtain the set of data responsive to the at least one predefined query.

In some instances, the request to synchronize the trained neural network to the client device comprises a request to initially synchronize the trained neural network to the client device.

In some instances, the request to synchronize the trained neural network to the client device comprises a request to perform a delta synchronization to the client device. In such instances, identifying the neural network model comprises identifying at least one change to the neural network model since a previous synchronization to the client device. Further, transmitting the representation of the trained neural network to the client device can include transmitting any modifications to the trained neural network to the client device and transmitting any modifications to the set of data defined by the identified input definition since the previous synchronization.

In some instances, the input definition includes at least one user input to be received at runtime.

Similar operations and processes may be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for synchronizing existing neural networks to client devices for execution of the neural network in an offline mode.

FIG. 2 represents an example of a simple neural network.

FIG. 3 represents an example flow for synchronizing an existing neural network to a client device for offline execution.

FIG. 4 represents an example flow for execution of an offline-capable neural network at a client device.

### DETAILED DESCRIPTION

The present disclosure describes systems and methods for implementing a solution for providing capabilities for synchronizing existing neural networks to client devices for execution of the neural network in an offline mode.

Applications, including business applications, can support an offline mode in which a user can use the application, e.g., on a mobile device, when the mobile device is offline (e.g., not connected to a network). The application can be designed so that features work the same or similarly in an offline mode as in an online mode. A feature that has not previously been provided in business applications in an offline mode is the ability to execute neural networks in an offline mode. The present solution describes a process for synchronizing one or more trained neural networks to one or more client devices (e.g., mobile devices) to allow those client devices to execute calculations and operations using the trained neural network without network connectivity to a backend system, where neural networks are normally executed and maintained.

In other words, the present solution describes a process and system for transferring and synchronizing at least a portion of a trained neural network to a client (e.g., mobile) device, where the mobile device is associated with at least one application or function used to execute the neural network. By synchronizing the trained neural network to the mobile device, the neural network can be used to execute particular applications in offline, non-connected environments. Alternatively, if a network connection is available but poor, the mobile device can use the synchronized neural network to execute the neural network in an offline manner without requiring a roundtrip to a backend system associated with the online version of the neural network. In association with the offline execution of the neural network on the mobile device, a method and process for generically determining the required business data used at least in part as input for the neural network can be performed during a synchronization process while the mobile device is in an online mode. At least a part of the backend business or other data used as a factor in the neural network's calculation and resultant output can be identified and can be synchronized to the mobile device as offline business or other data. Using the latest version of data and the offline version of the neural network available at the mobile device, the mobile device and/or its applications can execute calculations using the neural network based on the synchronized offline data without the requirement of a network connection.

The mobile device, or any similar client, may also be offline-capable independent of the neural network synchronization described herein. That is, at least a portion of the business and other backend data used by any applications executing or installed on the mobile device may be synchronized through other means of synchronization. For example, business object instances, such as sales quotes, sales orders, and customer data may be synchronized and available at the mobile device to allow for offline usage of the mobile application(s), where appropriate.

In some instances, the mobile application executing at the mobile device may perform a determination operation as to whether the offline mode should be used, or whether the online mode represents a better option. In instances where no network connectivity is available, the decision is simple. However, where the network connection is weak, the mobile application can determine whether the possibility of updated data at the backend system is worth the potential bottleneck or delay caused by the slow or otherwise poor connection. In some instances, a manual indication of online or offline mode can be provided via a user, while in others the mobile application can determine how to proceed based on a dynamic real-time analysis of the connection in light of the context of the neural network operations. For example, if the last synchronization was over a threshold time ago (e.g., 1 day ago, where the threshold is 3 hours), the benefits of obtaining updated data may be worth the delay in connecting with the network. Where the last synchronization was within a threshold time ago (e.g., only 30 minutes ago, where the threshold is 3 hours), the offline mode can be used and the synchronized data can be applied. Any suitable determination can be provided to allow the mobile application to execute the determination at runtime.

In some instances, end users at the mobile device may create new business data, such as sales quotes, during execution in a business mode for the application, where the new business data is considered by the calculations in the neural network. This newly created data generated after the last synchronization to the backend system can be considered with the synchronized data and used in executing the offline neural network and obtaining a particular result. When the next synchronization occurs, the business data created by the end user (e.g., the sales quote) can be synchronized to the backend system and can be used, along with any results associated with the business data, in additional training of the neural network on the backend system. In doing so, the neural network may be trained, or modified, to optimize the calculations based on new data. During the next synchronization, the modifications to the neural network can be provided to the mobile device and updated for the next offline use. Alternatively, the offline data created at the mobile device may not be used by or may be irrelevant to the neural network, and instead may be used for other reasons. Such information can also be provided back to the corresponding backend system and incorporated into the existing data.

Neural networks are trained at the backend system, where training the neural networks is defined as modifying the configuration of the neural network using updated data to better represent the expected outcomes and provide better, or more accurate, results. Any suitable training technique can be applied, including using stochastic gradient descent, among others, to provide better or more accurate results. The training of a neural network requires significant training data and large amounts of computational and processing power. As such, the mobile versions of the neural network represent previously-trained neural networks, where the neural networks at the backend system can be updated using higher-powered systems. Because the neural networks used for offline execution are static, their size can be very small while providing the latest (since the last synchronization) knowledge and operations associated with the neural network.

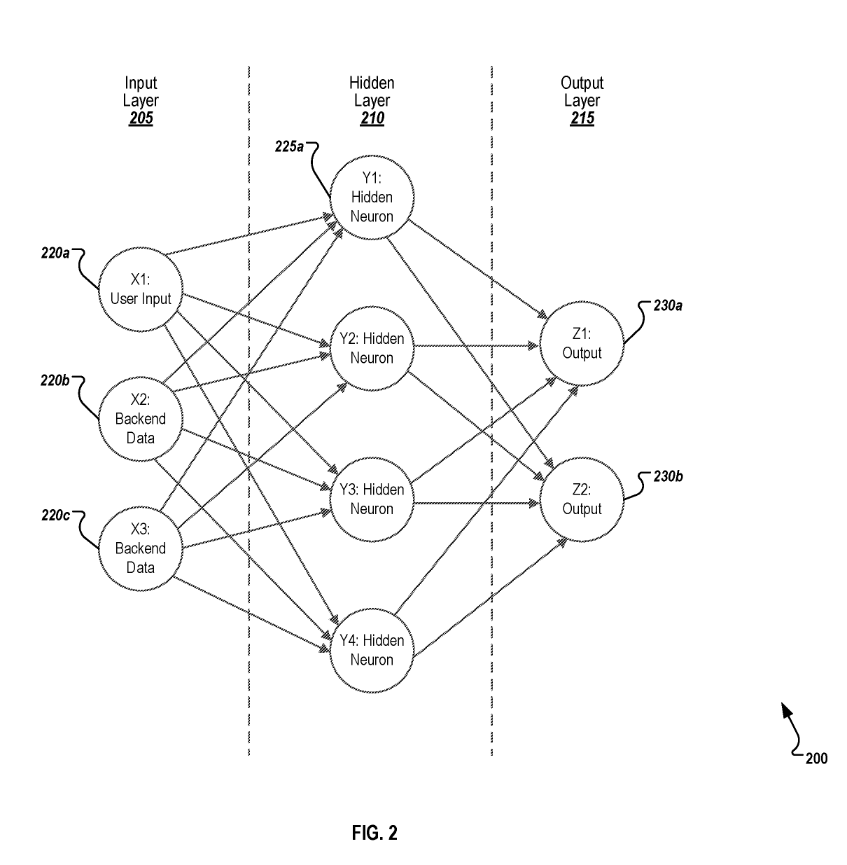

In general, neural networks can be used to provide predictive analytics and heavy-duty processing to various applications. FIG. 2 provides an illustrative example of a model of a basic neural network comprising multiple neurons. In particular, the neural network 200 represents a set of connected neurons 220, 225, 230. Neurons 220 on the left (e.g., the input layer 205), are called input neurons. The input neurons can be associated with any suitable data, and can be used as the input to the neural network for calculating one or more outputs resulting from the neural network's execution. In some instances, different types of data may be associated with the inputs. In FIG. 2, a first input neuron 220a is associated with some user input (e.g., received through a UI at the client), such as a particular quote value for a good or service. Two other input neurons 220b, 220c are illustrated in FIG. 2, including two neurons represented by input data/information defined by one or more sets of backend data. Examples of such inputs may be information associated with recent actions performed by the end user, recent information or transactions associated with a particular customer, person, or entity, or any other data used as input to the calculations. In general, neurons can receive input from other neurons or other external sources. Each neuron can compute some output based on that input or sets of input, and provide that output to an appropriate location. In some instances, that location may be another neuron, or the location may be as an output to the entire neural network. In some instances, the output of a particular neuron may be both. Returning to the input neurons 220, each input to those neurons can be associated with a particular weight, which is assigned on the basis of that input's relative importance to the other inputs to the particular neuron. The inputs associated with each input neuron 220 are illustrated as specific user input or a set of backend data. Each particular input neuron 220 may be associated with one or more inputs, where each input is assigned a weight based on the configuration of the neural network. In some instances, the neurons 220 of the input layer 205 do not perform any calculations, and instead pass their information to neurons 225 of the hidden layer 210. In some instances, a bias value or input may also be included as an input, the bias representing a trainable constant.

The middle layer of the illustrated model is called a hidden layer 210. Only a single hidden layer 210 is illustrated, but other neural networks can include multiple hidden layers. Where multiple hidden layers are present, the neural network 200 is called a deep neural network. The hidden neurons 225 of the hidden layer 210 have no direct connection to the outside world or external data sources. Instead, these hidden neurons 225 perform calculations and transfer information from the input neurons 220 to the output neurons 230.

The neurons on the right of the network 200 represent output neurons 230 in an output layer 215. The output neurons 230 are responsible for final computations and transferring information from the neural network 200 to the outside world. In many instances, one or more of the output neurons 230 may be associated with or bound to a user interface field or presentation, where the output of a particular output neuron 230 may be presented to the user via a user interface or portion of a user interface associated with an output.

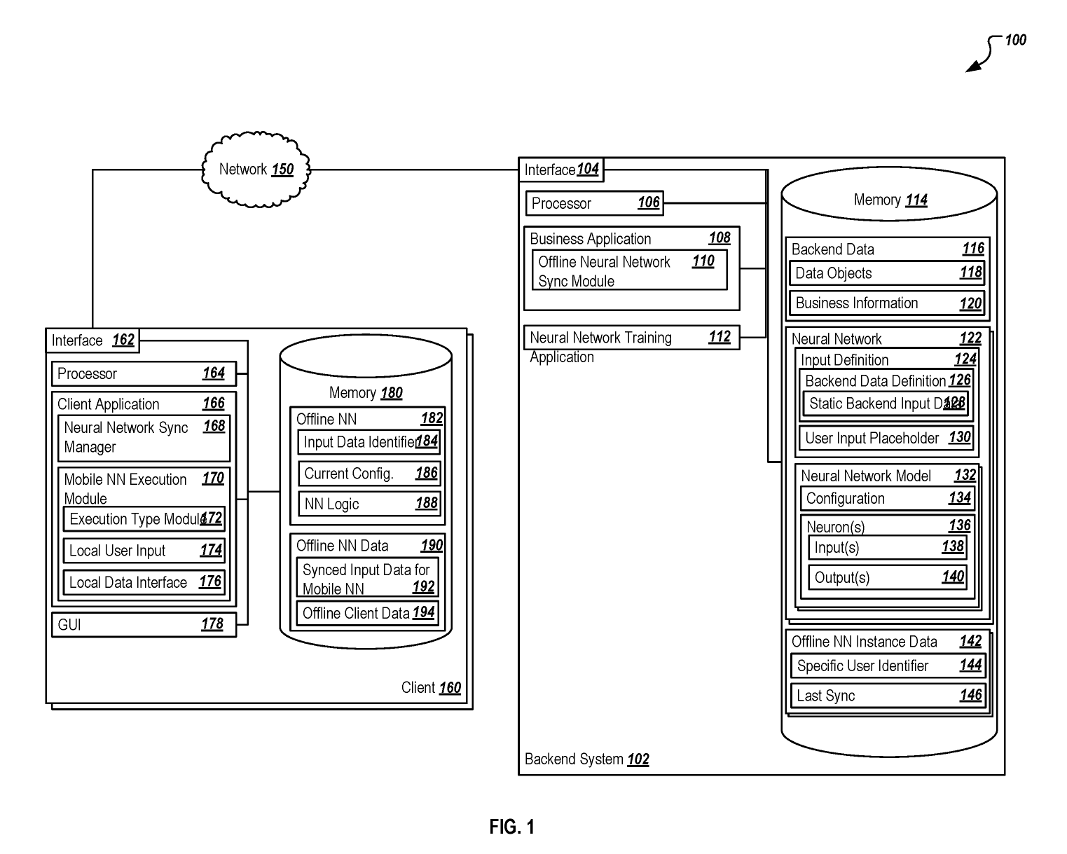

When a particular application and use of a neural network is performed in an online mode, the mobile device can obtain the relevant inputs from interactions at the mobile application (e.g., via user input) and based on recent or other relevant backend data that is associated with the neural network input neurons 220. In an offline mode, however, such information may not be available via the network connection, and any such information must be available at the mobile device's storage to be able to execute the neural network. Turning to the illustrated implementation, FIG. 1 is a block diagram illustrating an example system 100 for providing synchronization operations to allow existing neural networks to be available to mobile (or client) devices for execution of the neural network in an offline mode. As illustrated in FIG. 1, system 100 is associated with a backend system 102 at which an online execution of a neural network can be performed, and which can manage or assist in the synchronization of neural network-relevant backend data to the client as required for an offline execution of a neural network. The system 100 can allow the illustrated components to share and communicate information across devices and systems (e.g., backend system 102, client 160, among others, via network 150). In some instances, some or all of the components may be cloud-based components or solutions, while in others, non-cloud systems may be used. In some instances, non-cloud-based systems, such as on-premise systems, may use or adapt the processes described herein. Although components are shown individually, in some implementations, functionality of two or more components, systems, or servers may be provided by a single component, system, or server.

As used in the present disclosure, the term “computer” is intended to encompass any suitable processing device. For example, backend system 102 and client 160 may be any computer or processing device such as, for example, a blade server, general-purpose personal computer (PC), Mac®, workstation, UNIX-based workstation, or any other suitable device. Moreover, although FIG. 1 illustrates a single backend system 102, the system 100 can be implemented using a single system or more than those illustrated, as well as computers other than servers, including a server pool. In other words, the present disclosure contemplates computers other than general-purpose computers, as well as computers without conventional operating systems. As illustrated, the backend system 102 includes the operations and components associated with the execution of one or more business applications 108, a neural network training application 112, the offline synchronization of particular offline neural networks 182 and the related data needed to execute those networks 182, and the management and execution of one or more online neural networks 122. In alternative implementations, some or all of that functionality may be executed or associated with different systems, servers, or other computing devices. For example, neural networks 122 may be executed or trained on a separate system, including where those neural networks 122 are associated with particular business applications. Therefore, the illustration of system 100 is meant to be an illustrative example and is not meant to be limiting. Similarly, client 160 may be any system which can request data and/or interact with the backend system 102. Client 160, in some instances, may each or either be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others.

In general, the backend system 102 can be generally associated with the execution of one or more business applications 108. The business applications 108 may be any suitable applications, including non-business applications. At least some of the business applications 108 may be associated with one or more neural networks 122 used to predict or provide analysis of data based on one or more inputs to provide predictive outputs. As described, these neural networks 122 can be trained based on existing and newly created data to improve those neural networks 122 to provide better and more accurate outputs after additional training and refinement. The business application 108 may be an enterprise application in some instances, and can include but is not limited to an enterprise resource planning (ERP) system, a customer relationship management (CRM) system, a supplier relationship management (SRM) system, a supply chain management (SCM) system, a product lifecycle management (PLM) system, or any other suitable system. In some instances, the backend system 102 may be associated with or can execute a combination or at least some of these systems to provide an end-to-end enterprise application or portions thereof.

As illustrated, the backend system 102 may be associated with a memory 114 storing a number of relevant data sets and components. Memory 114 may represent a single memory or multiple memories. The memory 114 may include any memory or database module and may take the form of volatile or non-volatile memory including, without limitation, magnetic media, optical media, random access memory (RAM), read-only memory (ROM), removable media, or any other suitable local or remote memory component. The memory 114 may store various objects or data (e.g., backend data 116, neural network(s) 122, and offline neural network instance data 142, as well as others, etc.), including financial data, user information, administrative settings, password information, caches, applications, backup data, repositories storing business and/or dynamic information, and any other appropriate information associated with the backend system 102, including any parameters, variables, algorithms, instructions, rules, constraints, or references thereto. Additionally, the memory 114 may store any other appropriate data, such as VPN applications, firmware logs and policies, firewall policies, a security or access log, print or other reporting files, as well as others. While illustrated within the backend system 102, some or all of memory 114 may be located remote from the backend system 102 in some instances, including as a cloud application or repository, or as a separate cloud application or repository when the backend system 102 itself is a cloud-based system. In some instances, particularly in enterprise systems, the backend data 116 may be stored in a centralized repository to allow access to various applications and components in an end-to-end system.

The backend data 116 may be any suitable data used by the business application 108. In some instances, at least a portion of the backend data 116 may be relevant to one or more of the neural networks 122, where that backend data 116 is used as input to the neural network 122 to generate an appropriate output. The backend data 116 associated with a particular input can be defined in an input definition 124 of the neural network 122, and is described below. The backend data 116 can also include numerous sets of data that are not relevant to a particular neural network 122, but which is used in other processes and operations associated with particular business applications 108. The backend data 116 can include data objects 118 (e.g., business objects), data object instances, business information 120, or any suitable data. In some instances, at least some of the backend data 116 can be accessible directly by the business application 108 or other systems via access to a particular database or other storage system, while in other instances, at least some of the backend data 116 may be accessible via one or more queries executed upon the backend data 116 and its storage components, such as a particular database. Any suitable data or data types can be used as input to the neural network.

As illustrated, memory 114 also includes at least one neural network 122. Each neural network can be associated with an input definition 124, which describes the particular inputs required to allow the neural network 122 to be able to generate a corresponding output. The input definition 124 can specifically link to particular information, can identify a set of predefined queries or data accesses, or can include one or more user inputs that need to be received in order to execute. The input definition 124 can be generated or otherwise defined in any suitable format, and can be used to dynamically determine the inputs to a particular neural network 122 at runtime. For example, the input definition 124 may be associated with particular sets of data as they are associated with a particular user, entity, business, or organization. The backend data set definition 126 may identify a generic query, or a query with placeholders or other parameters to identify a particular person or entity (or set of persons or entities) with which a particular execution of the neural network 122 is associated. The runtime of the business application 108 or the appropriate location at which the neural network 122 is being associated can then use those defined input definitions 124, including the backend data definition 126, to access the particular set of data from the backend data 116 as required. Additionally, a set of static backend input data 128 may be associated with the backend data definition 126, where at least some of the data does not typically change. In such instances, the static backend input data 128 can be statically defined and used for particular neural network executions.

The input definition 124 of the neural network 122 may also include one or more user input placeholders 130. Those placeholders 130 can be used as placeholders for particular inputs provided by business applications 108 and/or users interacting with the neural network 122 (e.g., via a UI of the business application 108 with at least one input bound to a particular input of the neural network 122). These input placeholders 130 can receive particular inputs that are included in the calculation of the neural network execution along with the other data inputs associated with the backend data definition 126.

As illustrated, the neural network 122 includes a neural network model 132 used to define the particular neural network 122, its various neurons 136, the inputs 138 to those neurons 126, and the one or more outputs 140 associated with the various neurons 136. In some instances, the neural network model 132 can be represented as a graph (e.g., as a dependency graph, a directed acyclic graph, etc.). The neural network model 132 also includes a configuration 134, where the configuration provides information as to particular connections between the neurons 136, their respective weights, one or more biases included within the inputs, as well as other particular information relevant to the operations of the neural network 122. In particular, the configuration 134 of the neural network 132 can be updated over time by the neural network training application 112, which executes to continue to update and improve the configuration 134 of particular neural network models 132 as additional data and empirical data is received. By training the particular neural network 122, the outputs associated with the execution of the neural network 122 can continue to evolve and represent better and more accurate estimations and predictive analyses.

Memory 114 can also store data or information associated with one or more offline neural network instances 142 which have been previously synchronized to one or more clients 160 (e.g., mobile devices) using the present solution. In some instances, a specific user identifier 144 associated with a prior synchronization may be stored. When the client application 166 associated with the user attempts a synchronization, information about that synchronization can be accessed based on the corresponding user. Additionally, information about a last synchronization 146 may be available. Such information can allow the system, in some instances, to determine how or what type of synchronization to perform (e.g., an initial, full synchronization, a full synchronization based on a time since the last sync, or a delta synchronization, among others). Additional information may be used to identify and track particular offline neural networks 182. In some instances, the neural network(s) and/or their associated configurations may be versioned, allowing for multiple versions to be available for use or for updating the offline instances 142 stored at the client 160. If a particular configuration of an offline instance 142 has changed due to the neural network 122 being further trained in a training session by the neural network training application 112, the version associated with a particular neural network 122 can be increased, as well as any associated offline neural network instances 142. When synchronizing, the client 160 (e.g., via a neural network sync manager 168) can check to whether a particular offline neural network 182 available at the client 160 is equal to the current version of the neural network 122. Where the versions may be different, the backend system 102 may be able to calculate the differences between two versions of the neural network 122 (e.g., between current version 42 and version 37 as available at the client 160). In some instances, the backend system 102 may provide only a delta between the versions to overwrite or modify the configurations 186, neural network logic 188, or inputs 184 identified in the offline neural network 182.

As illustrated, the backend system 102 includes interface 104, processor 106, business application 108, and neural network training application 112. The interface 104 is used by the backend system 102 for communicating with other systems and components in a distributed environment—including within the environment 100—connected to the network 150, e.g., one or more clients 160, as well as other systems communicably coupled to the illustrated backend system 102 and/or network 150. Generally, the interface 104 comprises logic encoded in software and/or hardware in a suitable combination and operable to communicate with the network 150 and other components. More specifically, the interface 104 may comprise software supporting one or more communication protocols associated with communications such that the network 150 and/or interface's hardware is operable to communicate physical signals within and outside of the illustrated environment 100. Still further, the interface 104 may allow the backend system 102 to communicate with one or more clients 160 regarding particular offline neural network synchronizations, as described in the present disclosure.

Network 150 facilitates wireless or wireline communications between the components of the environment 100 (e.g., between the backend system 102 and a particular client 160), as well as with any other local or remote computer, such as additional mobile devices, clients, servers, databases, or other devices or components communicably coupled to network 150, including those not illustrated in FIG. 1. In the illustrated environment, the network 150 is depicted as a single network, but may be comprised of more than one network without departing from the scope of this disclosure, so long as at least a portion of the network 150 may facilitate communications between senders and recipients. In some instances, one or more of the illustrated components (e.g., the backend system 102) may be included within network 150 as one or more cloud-based services or operations. The network 150 may be all or a portion of an enterprise or secured network, while in another instance, at least a portion of the network 150 may represent a connection to the Internet. In some instances, a portion of the network 150 may be a virtual private network (VPN). Further, all or a portion of the network 150 can comprise either a wireline or wireless link. Example wireless links may include 802.11a/b/g/n/ac, 802.20, WiMax, LTE, and/or any other appropriate wireless link. In other words, the network 150 encompasses any internal or external network, networks, sub-network, or combination thereof operable to facilitate communications between various computing components inside and outside the illustrated environment 100. The network 150 may communicate, for example, Internet Protocol (IP) packets, Frame Relay frames, Asynchronous Transfer Mode (ATM) cells, voice, video, data, and other suitable information between network addresses. The network 150 may also include one or more local area networks (LANs), radio access networks (RANs), metropolitan area networks (MANs), wide area networks (WANs), all or a portion of the Internet, and/or any other communication system or systems at one or more locations.

The backend system 102 also includes one or more processors 106. Although illustrated as a single processor 106 in FIG. 1, multiple processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the backend system 102, in particular those related to the business application 108 and/or the neural network training application 112. Specifically, the processor(s) 106 executes the algorithms and operations described in the illustrated figures, as well as the various software modules and functionality, including the functionality for sending communications to and receiving transmissions from clients 160, as well as to other devices and systems. Each processor 106 may have a single or multiple core, with each core available to host and execute an individual processing thread.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

As described, the business application 108 may be any suitable application or software associated with at least one neural network 122. The at least one neural network 122 can be associated with particular calculations or predictive analyses related to the operations of the business application 108, such that users of the business application 108 can execute the neural network 122 to receive output identifying the expected or analyzed result based on the trained configuration 134 and the particular inputs to the particular neural network 122.

In the present illustration, the business application 108 includes or is associated with an offline neural network sync module 110, where the offline neural network sync module 110 allows online neural networks 122 to be synced to one or more clients 160 such that those neural networks 122 can be represented as offline neural networks 182. The offline neural networks 182 can be executed on the client 160 without the need for a network connection and calls to the backend system 102 and the online neural network 122. In some instances, additional situations may occur where the offline neural network 182 is used instead of the online neural network 122, even where a network connection exists. For example, the quality, speed, or latency of the network connection may be such that the time needed to perform an online execution is likely to be more than an offline execution. In those instances, the offline neural network 182 can be used instead. Alternatively, the speed of executing the offline neural network 182 may be faster than the roundtrip required for the online neural network 122, particularly where a time since the last sync of the offline neural network 182 was with a particular time threshold such that the offline neural network data 190 is considered fresh, or otherwise not outdated. The offline neural network sync module 110 can assist in performing or managing the synchronization operations for particular instances of the offline neural networks 182.

To perform the synchronization process, the module 110 can determine that an existing neural network 122 is ready to be synced to a particular client 160. For an initial synchronization, the module 110 can perform a full synchronization. In some instances, the determination to synchronize may be based on an indication received from the client 160, such as from the neural network sync manager 168 executing as part of a client application 166. In other instances, alternative triggers initiating the synchronization may be received. In some instances, the module 110 may provide an initial offline neural network 182 to the client 160, where the offline neural network 182 includes an input data identifier 184, a current configuration 186 (corresponding to the configuration 134 at the time of synchronization), and a set of neural network logic 188 based on the neural network model 132. The input data identifier 184 may be similar or related to the input definition 124, and can determine what information is needed for the offline neural network 182 to execute. In some instances, particular predefined queries or sets of information may be described by the input data identifier 184, and can be used to determine what backend data 116 or user input data may be needed to execute the offline neural network 184. In some instances, the input data identifier 184 may also be updated to identify where the necessary information is stored on the client 160, such as at the synced input data 192 and/or the offline client data 194. Once the initial offline neural network 182 is delivered, the neural network sync manager 168 of the client application 166 may perform the operations for synchronizing the offline neural network 182 and any associated offline neural network data 190. In other instances, requests for synchronization may be routed through the offline neural network sync module 110.

In synchronizing the offline neural network 182, the input definition 124 can be accessed from the neural network 122 being synchronized. Based on the input definition 124, the corresponding set of input data associated with the backend data 116 can be accessed, as appropriate, to obtain and provide the required input data to the mobile neural network 182, where the synced input data 192 can be stored within a set of offline neural network data 190. Using the predefined queries and/or the defined input locations or definitions of the input definition 124, the current state of the data required to execute the offline neural network 182 can be provided to and stored at the client 160 to allow for offline execution of the neural network 182. Additionally, the current neural network logic 188 as derived from the neural network model 132 can be created and provided to the offline neural network 182. The offline neural network sync module 110 can ensure that in response to synchronization requests a current set of input data is made available to the offline neural network and stored in the offline neural network data 190.

In some instances, the offline neural network sync module 110 can assist in performing delta synchronizations, where needed. In those instances, a full set of neural network information may not need to be exchanged. Instead, in response to a request for a synchronization, the offline neural network sync module 110 can determine a set of neural network-relevant information that has changed since the last synchronization (e.g., as identified by the last sync information 146 for a particular offline neural network 182). The modified data, which can include backend data 116, particular changes to specific inputs, modified configurations 134 (e.g., different weightings of inputs to particular neurons), or other suitable portions of the neural network 122, can be provided to the offline neural network 182 and/or the set of offline neural network data 190.

In some instances, the neural network sync manager 168 can send information added at the client 160 while the client 160 operated in an offline mode to the backend system 102 to allow for updates to the backend data 116. For example, a new instance of a business object or other business-related data may be created and/or modified at the client 160 while in offline mode for use during execution of the client application 166. That information may be actual business data to be returned to the backend data 116 upon reconnection. As such, in response to the next synchronization (or another suitable synchronization), the neural network sync manager 168 can send the updated information back to the backend data 116. In some instances, the new information may be used in an offline execution of the offline neural network 182. In such instances, the new data may be stored as offline client data 194 until incorporated into the backend data 116. In some instances, the offline neural network 182 may use that offline client data 194 to execute and generate output in the offline mode. Once the offline client data 194 is synced to the backend data 116, an additional training session performed by the neural network training application 112 may modify the neural network 122 in some way, such as a change to its configuration 134. In some instances, the neural network 122 can be executed again and any modifications to the output can be provided back to the client application 166.

While the offline neural network 182 requires synchronization of data for the offline neural network 182 to execute, other synchronizations performed at the client 160 may also obtain information relevant to the neural network 182, such as through client application-relevant business information used outside neural network operations. In some instances, that data may include data to be used in the offline execution of the offline neural network 182, meaning that a further synchronization in association with the offline neural network 182 may be unnecessary. In those instances, the neural network sync manager 168 (or alternatively the offline neural network sync module 110) can perform a check or comparison of data which is already available at the client 160 and only initiate or request the synchronization of the missing data needed for the offline execution of the offline neural network 182 that is not already available. In doing so, the cost of the neural network synchronization can be lowered by avoiding duplicative synchronization operations for already obtained data.

The neural network training application 112 can be any training-related set of operations and functionality used to update and improve the neural network 122 and its configuration 134. The process performed by the application 112 can be an iterative learning process in which data is presented to the network and the weights of particular input values being adjusted based on the new data. One example algorithm used to train the neural network 122 may be a back-propagation algorithm, although any suitable algorithm or process may be used. Once new configurations 134 are determined they can be transmitted and synchronized back to the offline neural network 182 during the next synchronization.

As illustrated and described, one or more clients 160 may be present in the example system 100. Each client 160 may be associated with requests transmitted to the backend system 102 related to the client application 166 executing on or at the client 160. In particular, and as described above, the client applications 166 may be associated with one or more offline neural networks 182 made available through the described synchronization operations to provide the functionality of the one or more online neural networks 122 to the client 160 even when operating in an offline mode. As illustrated, the clients 160 may include an interface 162 for communication (similar to or different from interface 104), a processor 164 (similar to or different from processor 106), the client application 166, memory 180 (similar to or different from memory 120), and a graphical user interface (GUI) 178.

The illustrated client 160 is intended to encompass any computing device such as a desktop computer, laptop/notebook computer, mobile device, smartphone, personal data assistant (PDA), tablet computing device, one or more processors within these devices, or any other suitable processing device. In general, client 160 and its components may be adapted to execute any operating system, including Linux, UNIX, Windows, Mac OS®, Java™, Android™, or iOS. In some instances, client 160 may comprise a computer that includes an input device, such as a keypad, touch screen, or other device(s) that can interact with the client application 166 to execute the offline neural network 182, where appropriate, and an output device that conveys information associated with the operation of the applications and their application windows to the user of the client 160. Such information may include digital data, visual information, or a GUI 178 as shown with respect to client 160. Specifically, client 160 may be any computing device operable to communicate queries or communications to the backend system 102, other clients 160, and/or other components via network 150, as well as with the network 150 itself, using a wireline or wireless connection. In general, client 160 comprises an electronic computer device operable to receive, transmit, process, and store any appropriate data associated with the environment 100 of FIG. 1. In some instances, different clients 160 may be the same or different types or classes of computing devices. For example, at least one of clients 160 may be associated with a mobile device (e.g., a tablet), while at least one of the clients 160 may be associated with a desktop or laptop computing system. Any combination of device types may be used, where appropriate.

Client application 166 may be any suitable application, program, mobile app, or other components. As illustrated, client application 166 interacts with the backend system 102 to perform client-side operations associated with a particular business application 108, and may be a client-side agent of the business applications 108, a mobile version of the business application 108, or a mobile application associated with and allowing interaction with or execution of functionality associated with the busines application 108, in some instances. When in an online mode, operations associated with a particular neural network 122 can be executed by sending requests for execution via network 150 and receiving the output of the operations at the client application 166. In an offline mode (e.g., where no network connection is available, where the available network connection is poor, unreliable, unable to be used, determined to be slower than the offline execution, etc.), the client application 166 can execute the offline neural network 182 as currently synchronized to the client 160 for execution.

As illustrated, the client application 166 may include various components, including the neural network sync manager 168 and the mobile neural network execution module 170. The neural network sync manager 168 can be used in combination with or in lieu of the offline neural network sync module 110. In some instances, when the client 160 is available to synchronize with the backend system 102, the neural network sync manager 168 can identify the particular input data needed from the input data identifier 184 and/or a copy of the input definition 124 and obtain that information using any suitable method or process. Alternatively, the neural network sync manager 168 can trigger, via a communication to the offline neural network sync module 110, an initiation of a syncing operation where the syncing is managed by the offline neural network sync module 110.

The mobile neural network execution module 170 manages the execution of the neural network in the offline mode, including determining whether the offline execution is necessary or requested. The execution type module 172 can perform a determination or analysis of the current state of the client 160, including the status of the current network connection. If a network connection is available and at or above a particular threshold speed and/or quality, the execution type module 172 can determine that an online execution would be preferable, and can direct the client application 166 to use the online neural network 122 for any particular interactions. If, however, the network connection is not available or is not above the particular threshold speed and/or quality, the execution type module 172 can determine that an offline mode execution is proper, and route any attempted client application 166 operations to the offline neural network 182. The mobile neural network execution module 170 can be associated with or can determine one or more local user inputs 174 associated with the inputs to the offline neural network 182, and can combine that input with the synced input data for the offline neural network 192 to provide as input to the offline neural network 182. As noted, one or more local data interfaces 176 may be provided for the inputting of information to or associated with the client application 166 and the offline neural network 182. These interfaces 176 may be one or more screens, input fields, or the like, and can be associated with a particular user input 174 received from the user of the client 160.

GUI 178 of client 160 can interface with at least a portion of the environment 100 for any suitable purpose, including generating a visual representation of the client application 166 and/or the content associated with client application 166, as well as visual representations of the business application 108 or other operations of the backend system 102. In particular, the GUIs 178 may be used to present screens or UIs associated with the client applications 166 (e.g., the local data interface 176). The GUI 178 may also be used to view and interact with various Web pages, applications, and Web services located local or external to client 160. Generally, the GUI 178 provides users with an efficient and user-friendly presentation of data provided by or communicated within the system. GUI 178 may comprise a plurality of customizable frames or views having interactive fields, pull-down lists, and buttons operated by the user. For example, GUI 178 may provide interactive elements that allow a user to view or interact with information related to the operations of processes associated with the backend system 102, including the presentation of and interaction with particular application data associated with the client application 166 and business application 108, among others. In general, GUI 178 is often configurable, supports a combination of tables and graphs (bar, line, pie, status dials, etc.), and is able to build real-time portals, application windows, and presentations. Therefore, GUI 178 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

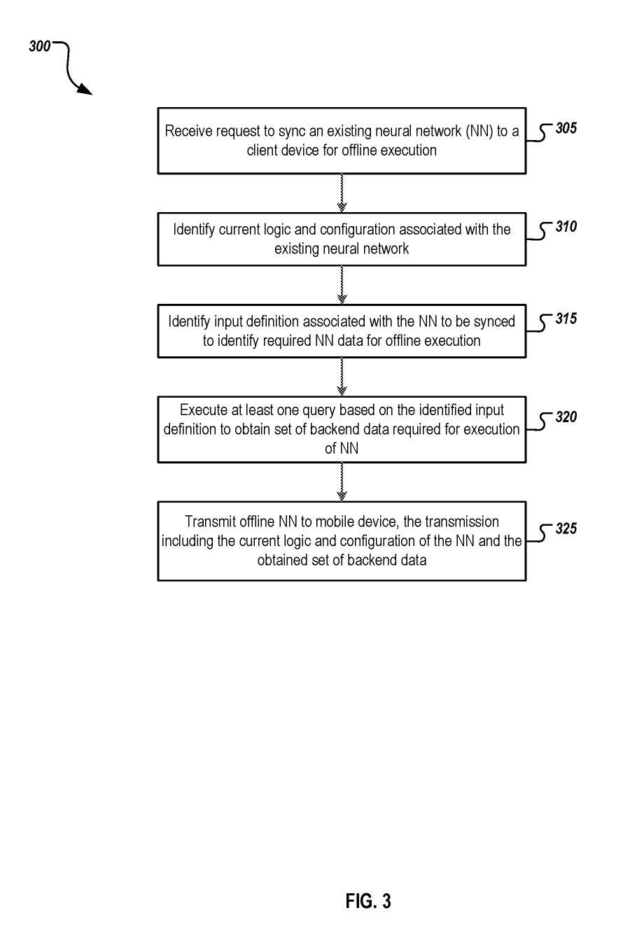

FIG. 3 represents an example flow for synchronizing an existing neural network to a client device for offline execution in one implementation. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate.

At 305, a request to synchronize an existing neural network to a client device for potential offline execution is received. The client device may be a mobile device, such as a smartphone or tablet, which may be used in areas or locations without network connections, or in locations with poor or slow connections. The request to synchronize the neural network can be generated by the client device and/or a backend system associated with the existing neural network, and may be triggered by an indication from a client application executing on the client device that is associated with the existing neural network that the client is available for synchronization. In some instances, the request may specifically identified whether a full sync is required or whether the request is for a partial or delta sync to update the backend data associated with the neural network as it has been modified since a last synchronization. In some instances, the determination of whether a full sync is required or not is dynamically determined at the backend system, such as by comparing a particular user or client identifier received or associated with the request to information stored on the backend system. In some instances, if no previous sync has been performed, an initial sync process can be performed to provide all relevant data. If a prior sync has been performed, a determination can be made as to whether some or all of the previous information is older than a preset or dynamic threshold age, such that a full sync is needed. In some instances, the full or delta sync determination may be dynamically based, at least in part, on the quality of the network connection with the client device. In some implementations, at least some of the data (e.g., quotes, sales orders, etc.) may have or be associated with a LastChangedData value. By comparing the LastChangedData value of the client's data and the backend system's data, a determination can be made as to whether the particular data needs to be synchronized again. A full sync, in some instances, may only take place once as an initial sync or in response to a specific instruction from a user to perform a full sync.

At 310, a current logic and configuration associated with the existing neural network is identified. The current logic associated with the neural network can be the combination of neurons associated with the existing neural network. In some instances, the current logic can be derived from a neural network model identifying a set of neurons, one or more inputs, and the associated output(s) of the neural network. In some instances, the current logic of the existing neural network can be transformed or formatted into an appropriate format, including one or more matrices that identify the particular inputs and operations performed based on those inputs, including at one or more hidden layers within the neural network. The configuration of the existing neural network can be associated with one or more weights and/or biases associated with various inputs to particular neurons. The configuration can be updated on a regular basis in response to ongoing neural network training, and can be used to modify the operations and outcomes of particular neural network operations as additional learning is performed over time. In some instances, the configuration may be identified based on the existing neural network's current status, including connection weights associated with inputs to particular neurons. In some instances, where a delta sync is being performed, a determination can be made as to whether any changes to the logic and/or configuration of the neural network has changed since the prior sync. If not, the current logic and configuration may not need to be provided during the delta sync. If one or the other has changed since the last sync, then those changed values can be provided with the synchronization transmission.

At 315, an input definition associated with the existing neural network can be identified, where the input definition includes an identification of the particular inputs required by the neural network for offline execution. The input definition can identify particular sets of backend data that are used as inputs into the neural network. In some instances, the input definition can identify one or more predefined or partially predefined queries or data sets that may need to be obtained in order for the neural network to be executed properly. In some instances the input definition may be hard-coded with a particular data set, while in others the required data sets may be dynamically determined based on a description of the information required. For example, if a particular analysis relates to the operations of a specific user, a set of user-related information may be needed to perform a particular neural network execution. As such, the input data identified in the input definition may represent a query to a particular database, data set, or other source with a placeholder specific to the person or entity associated with the offline execution of the neural network. When the information is to be obtained or accessed, the placeholder can be associated with the particular entity or context-relevant information and a full query can be formed. In some instances, at least a portion of the input definition can define user input received at runtime as part of the input. In such instances, the user input can be received at runtime via a client-side application used to initiate the offline neural network execution. The client-side application may be associated with one or more UIs including input fields that allow the user input to be received at runtime.

At 320, at least one query based on the identified input definition can be executed to obtain a set of backend data required for offline execution of the neural network. As noted, the executed queries can be predefined for the particular neural network in the input definition, while in other instances the executed queries may be dynamically derived based on the information required for a particular neural network execution. For example, if the inputs to the particular neural network are defined as a prior 100 quotes provided to entity X, then the derived query may be generated to access the last 100 quotes for entity X without being hard-coded or predefined. In some instances, particularly where the sync process is associated with a delta sync from a prior full synchronization or one or more previous delta syncs, obtaining the set of backend data may comprise obtaining a set of data that has changed since the previous synchronization for providing to the client device. In some instances, information about the time of the last sync may be stored at the backend system and/or provided by the client device. The at least one queries can be filtered, either initially or after the result set is obtained, to return or provide only those data sets that have been changed or modified since the last synchronization. In some instances, backend data associated with the input definition can be synced to the client device for purposes other than the neural network synchronization process, such as other business or user-related needs or operations. In those instances, the data already stored at the device

At 325, the identified logic and configuration of the existing neural network as identified (at 310) and the obtained backend data required for execution of the offline neural network can be transmitted to the client device for storage. In some instances, the client device may perform the request for the particular backend data, while in others, the backend system can obtain or identify the backend data as required and can provide that data to the client device. As noted, a subset of the logic, configuration, and the backend data can be transmitted to the client device when the synchronization represents a delta or partial sync. The information transmitted in those instances can overwrite or otherwise replace the offline neural network definition and/or data already stored at the client device, such that the offline neural network is considered updated and current at the time of the transmission.

As previously described, the neural network can be represented as a graph with weights on edges and a bias on different nodes. There are several formats for storing/transferring these graphs, e.g., as a GraphML file format or as a Graph eXChange Language (GXL) file format. Any suitable alternative format can also be used to share or transmit the neural network. Example underlying languages of the description may include XML or JSON.

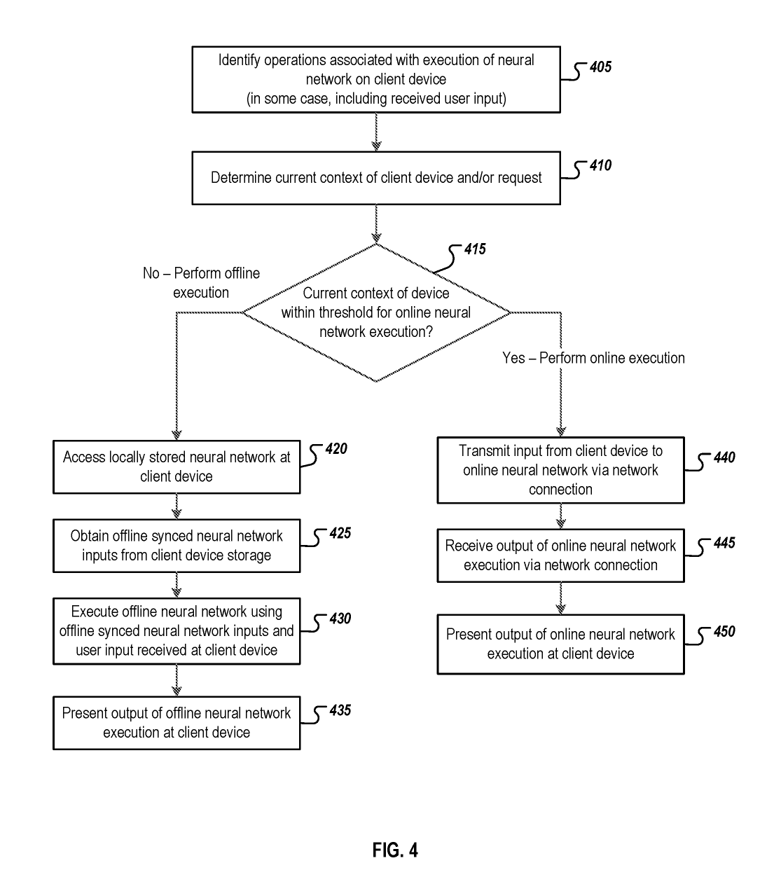

FIG. 4 represents an example flow for execution of an offline-capable neural network at a client device. For clarity of presentation, the description that follows generally describes method 400 in the context of the system 100 illustrated in FIG. 1. However, it will be understood that method 400 may be performed, for example, by any other suitable system, environment, software, and hardware, or a combination of systems, environments, software, and hardware as appropriate. In some instances, method 400 of FIG. 4 may be performed by a client device at which the operations of method 300 of FIG. 3 have already been performed.

At 405, operations associated with the execution of a particular neural network are identified at the client device. In some cases, an explicit instruction or input associated with a business or client application executing at the client device may be received via user input or user operations. In others, the operations may be automatically triggered by one or more related actions or operations within the client application, such that an execution of the neural network is triggered. In some instances, new user input may be received via the client application that can be used as an input to the neural network (e.g., as identified as a user input placeholder 130), and which is to be used during execution as a particular input value or parameter.

At 410, a current context of the client device and/or a request associated with the identified operations associated with the execution can be determined. In particular, a determination can be as to the current network connectivity and connection strength and reliability of the client device. If the device is connected to a WiFi connection, then an online neural network execution may be proper. If, however, the device has no network connectivity or if the available network connectivity is poor or below a particular predefined threshold, then an offline neural network execution may be used. In some instances, the client application associated with the neural network execution may allow users to indicate whether an online or an offline execution is required. In other instances, the client application can dynamically estimate the time likely to be taken using the online execution (e.g., roundtrip of request, processing, and returned results) versus the time required to execute the offline neural network. In still other instances, a determination of whether the client application is executing in an offline mode at the time of the request may be made.

Once the context or request parameters are determined, at 415 the client device can determine whether the current context is within a particular threshold required for executing an online neural network. Again, this threshold may be associated with a predefined network connection speed or quality, a dynamic determination of whether the time and resources required to execute the online version are greater than the offline execution, an indication that the client application is currently executing in an offline mode, or any other suitable determination can be used to determine the type of execution to be performed. If an offline execution of the neural network is to be performed, method 400 continues at 420. If an online execution of the neural network is to be performed, method 400 continues at 440.

Turning to the offline execution, at 420 a locally stored neural network is accessed at the client device. In many instances, the format of the locally stored neural network is provided as a matrix values associated with a set of inputs that is used to calculate the results of the execution. The format of the locally stored neural network can be more compact than the neural network stored at the backend system, and can be a relatively simple set of calculations executed in response to one or more inputs, including inputs associated with synced backend data and/or user inputs received at 405.

At 425, the offline synced neural network inputs or data stored in the client device's storage or memory can be accessed or obtained as inputs to the offline neural network. At 430, using those obtained inputs and any user inputs associated with the current execution of the neural network, the offline neural network can be executed. In response to the execution, at 435, the output of the offline neural network execution can be presented at a user interface of the client device.

Returning to 415, when the current context of the client device and/or the client application are such that they are within the threshold for online neural network execution, method 400 continues at 440. At 440, any user input provided by the client application to the backend system hosting or performing the execution of the online neural network via the client device's network connection. The online neural network can access the current backend data associated with the inputs to the neural network and execute the logic of the neural network in response to the specific request and any associated user input. As the online neural network is executed apart from the client device, the client device can then receive the output of the online neural network's execution via the network connection at 445. At 450, the received output can then be presented at the client device in response to the requested or triggered execution of the neural network.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computerized method executed by at least one processor, the method comprising:
identifying a request to synchronize a trained neural network from a backend system to a client device, wherein synchronizing the trained neural network to the client device enables offline execution of the trained neural network; and
in response to identifying the request:
identifying a neural network model defining the trained neural network, the neural network model associated with a current configuration;
identifying an input definition associated with the trained neural network, wherein the input definition defines a set of data required as input for the trained neural network to execute;
obtaining the set of data defined by the identified input definition; and
transmitting a representation of the trained neural network to the client device, wherein the transmitted representation includes an offline version of the neural network model and the current configuration of the trained neural network and the obtained set of data.

2. The method of claim 1, further comprising storing the representation of the trained neural network at the client device in response to the transmission.

3. The method of claim 2, wherein, in response to a request to execute the trained neural network at the client device, the client device executes the trained neural network using the offline version of the neural network model and the current configuration of the trained neural network and the obtained set of data.

4. The method of claim 1, wherein the client device comprises a mobile device.

5. The method of claim 1, wherein the input definition defines at least one predefined query associated with the set of data required as input for the trained neural network to execute, and wherein obtaining the set of data defined by the identified input definition comprises executing the at least one predefined query on a set of backend data to obtain the set of data responsive to the at least one predefined query.

6. The method of claim 1, wherein the request to synchronize the trained neural network to the client device comprises a request to initially synchronize the trained neural network to the client device.

7. The method of claim 1, wherein the request to synchronize the trained neural network to the client device comprises a request to perform a delta synchronization to the client device, wherein identifying the neural network model comprises identifying at least one change to the neural network model since a previous synchronization to the client device, and wherein transmitting the representation of the trained neural network to the client device comprises transmitting any modifications to the trained neural network to the client device and transmitting any modifications to the set of data defined by the identified input definition since the previous synchronization.

8. The method of claim 1, wherein the input definition includes at least one user input to be received at runtime.

9. A system comprising:
at least one processor; and
a memory communicatively coupled to the at least one processor, the memory storing instructions which, when executed, cause the at least one processor to perform operations comprising:
identifying a request to synchronize a trained neural network from a backend system to a client device, wherein synchronizing the trained neural network to the client device enables offline execution of the trained neural network; and
in response to identifying the request:
identifying a neural network model defining the trained neural network, the neural network model associated with a current configuration;
identifying an input definition associated with the trained neural network, wherein the input definition defines a set of data required as input for the trained neural network to execute;
obtaining the set of data defined by the identified input definition; and
transmitting a representation of the trained neural network to the client device, wherein the transmitted representation includes an offline version of the neural network model and the current configuration of the trained neural network and the obtained set of data.

10. The system of claim 9, the operations further comprising storing the representation of the trained neural network at the client device in response to the transmission.

11. The system of claim 10, wherein, in response to a request to execute the trained neural network at the client device, the client device executes the trained neural network using the offline version of the neural network model and the current configuration of the trained neural network and the obtained set of data.

12. The system of claim 9, wherein the client device comprises a mobile device.

13. The system of claim 9, wherein the input definition defines at least one predefined query associated with the set of data required as input for the trained neural network to execute, and wherein obtaining the set of data defined by the identified input definition comprises executing the at least one predefined query on a set of backend data to obtain the set of data responsive to the at least one predefined query.

14. The system of claim 9, wherein the request to synchronize the trained neural network to the client device comprises a request to initially synchronize the trained neural network to the client device.

15. The system of claim 9, wherein the request to synchronize the trained neural network to the client device comprises a request to perform a delta synchronization to the client device, wherein identifying the neural network model comprises identifying at least one change to the neural network model since a previous synchronization to the client device, and wherein transmitting the representation of the trained neural network to the client device comprises transmitting any modifications to the trained neural network to the client device and transmitting any modifications to the set of data defined by the identified input definition since the previous synchronization.

16. The system of claim 9, wherein the input definition includes at least one user input to be received at runtime.

17. A non-transitory computer-readable medium storing instructions which, when executed, cause at least one processor to perform operations comprising:
identifying a request to synchronize a trained neural network from a backend system to a client device, wherein synchronizing the trained neural network to the client device enables offline execution of the trained neural network; and
in response to identifying the request:
identifying a neural network model defining the trained neural network, the neural network model associated with a current configuration;
identifying an input definition associated with the trained neural network, wherein the input definition defines a set of data required as input for the trained neural network to execute;
obtaining the set of data defined by the identified input definition; and
transmitting a representation of the trained neural network to the client device, wherein the transmitted representation includes an offline version of the neural network model and the current configuration of the trained neural network and the obtained set of data.

18. The computer-readable medium of claim 17, the operations further comprising storing the representation of the trained neural network at the client device in response to the transmission; and
wherein, in response to a request to execute the trained neural network at the client device, the client device executes the trained neural network using the offline version of the neural network model and the current configuration of the trained neural network and the obtained set of data.

19. The computer-readable medium of claim 17, wherein the input definition defines at least one predefined query associated with the set of data required as input for the trained neural network to execute, and wherein obtaining the set of data defined by the identified input definition comprises executing the at least one predefined query on a set of backend data to obtain the set of data responsive to the at least one predefined query.

20. The computer-readable medium of claim 17, wherein the request to synchronize the trained neural network to the client device comprises a request to perform a delta synchronization to the client device, wherein identifying the neural network model comprises identifying at least one change to the neural network model since a previous synchronization to the client device, and wherein transmitting the representation of the trained neural network to the client device comprises transmitting any modifications to the trained neural network to the client device and transmitting any modifications to the set of data defined by the identified input definition since the previous synchronization.
